(19) United States
(12) Patent Application Publication
(10) Pub. No.: US 2004/0126220 A1
(43) Pub. Date: Jul. 1, 2004

(54) Front opening shipping box

(76) Inventors: Ryan Lee Howell, Olympia, WA (US); James E. Stoutenburg, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/335,114

(22) Filed: Dec. 31, 2002

(51) Int. Cl. B65G 1/00

(52) U.S. Cl. 414/800

(57) ABSTRACT

An apparatus including a thermoformed or blow-molded tote suitable for containing a plurality of wafers in an arrangement that permits machine interaction with one or more of the plurality of the wafers within the tote. A method including loading a plurality of wafers in a thermoformed or blow-molded tote onto a tool load port of a machine; and selecting at least one of the plurality of wafers from the tote.

### FIELD

Shipping box containers and, more particularly, front-opening shipping boxes to ship wafers and/or wafer containing integrated circuits.

### BACKGROUND

Front-opening shipping boxes (FOSBs) are generally used to ship wafers from wafer suppliers to their customers. A FOSB may also be used within/between integrated circuits (IC) manufacturing facilities and to/from IC manufacturers. A FOSB may further be used to transfer product from an IC manufacturing facility to suppliers or customers.

A FOSB may serve to directly transfer wafers from the FOSB to a front opening unified pod (FOUP) or open cassette inside an integrated circuit manufacturer facility. Wafers are generally transferred from a FOSB to a FOUP or cassette, typically, by automated methods. FOSBs for 300 millimeter wafers typically can accommodate 13 to 25 wafers.

One issue with respect to current FOSBs (e.g., injection molded FOSBs) is the cost associated with the FOSB. Therefore, wafer manufacturers generally reuse FOSBs. Thus, an IC manufacturer transfers or processes the wafers from the FOSB then returns the empty FOSB to its originating point of use (e.g., IC manufacturing facilities) or a recycling center. Once the FOSB is returned to the desired location, the FOSB is cleaned and prepared for subsequent use in transferring wafers. The shipping, handling and cleaning of recycled FOSBs can add significant costs to the wafer manufacturing process.

### BRIEF DESCRIPTION OF THE DRAWINGS

Features, aspects, and advantages of embodiments of the invention will become more thoroughly apparent from the following detailed description, appended claims, and accompanying drawings in which:

FIG. 1 shows a perspective top view of a thermoformed front-opening shipping box (FOSB).

FIG. 2 shows the FOSB of FIG. 1 with the front door removed to reveal the interior of the FOSB.

FIG. 3 shows a cross-section through line A-A′ of FIG. 2 and illustrates of wafer support features on the interior of one side panel of the FOSB of FIG. 1.

FIG. 4 shows a cross-section through line B-B′ of FIG. 2 and illustrates wafer support features on the interior of the FOSB of FIG. 1.

FIG. 5 shows an interior side view of one wafer support shelf of one side panel of the FOSB of FIG. 1.

FIG. 6 shows a first side view of the top and sides of the FOSB of FIG. 1 in a linear arrangement.

FIG. 7 shows a second view of the top and side view of the FOSB of FIG. 1 in a linear arrangement.

FIG. 8 shows an exploded top front perspective view of the FOSB of FIG. 1.

FIG. 9 shows a flow chart of an embodiment of forming a FOSB.

FIG. 10 shows a first side view of the top, bottom and sides of another embodiment of a FOSB in a planar arrangement.

FIG. 11 shows the FOSB of FIG. 9 being folded into a box structure.

FIG. 12 shows an embodiment of a FOSB compatible with an automated door.

### DETAILED DESCRIPTION

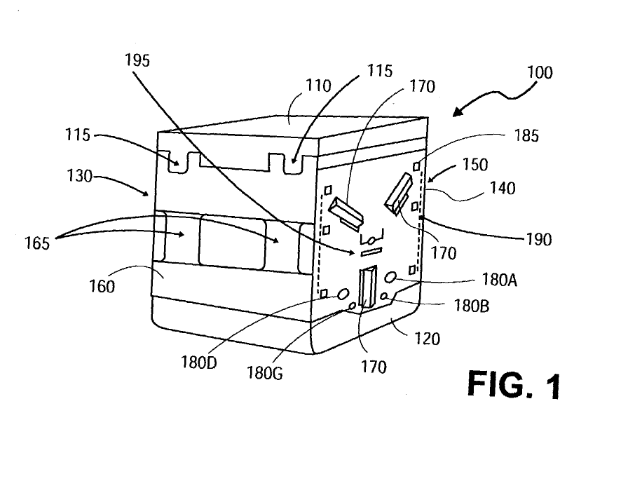

Referring to FIG. 1, a tote configured as a front-opening shipping box (FOSB) is shown. In one embodiment, FOSB 100 is suitable for use in shipping wafers from wafer suppliers (e.g., manufacturers) to their customers (typically integrated circuit (IC) manufacturers), within/between IC manufacturers, or from IC manufacturers to customers or suppliers. Representatively, FOSB 100 is suitable for shipping 300 millimeter (mm) wafers, typically any number up to 25 wafers.

FOSB 100 is illustrated in the form of a box (e.g., a rectangular box) having door 110 (e.g., a removable door) connected to the body of the box. The body of FOSB 100 includes top 130, base 140, first side 150, and second side 160. Rear 120 is connected to the body of FOSB 100 opposite the door. In one embodiment, FOSB 100 is designed to comply with a standard technically approved by the Global Physical Interfaces and Carriers Committee. Currently, the specification governing FOSBs to ship 300 mm wafers is SEMI M31-0999, titled “Provisional Mechanical Specification for Front-Opening Shipping Box Used to Transport and Ship 300 mm Wafers,” published by Semiconductor Equipment and Materials International in 1998 and in June 1999 (www.semi.org).

In one embodiment, the individual components of FOSB 100 (door 110, rear 120, top 130, bottom 140, first side 150, and second side 160) are thermoformed components, such as a polymer or plastic material. Thermoforming generally describes a manufacturing of plastic parts by preheating a sheet of plastic, bringing the sheet of plastic in the contact with a mold whose shape the plastic takes. In one embodiment, one or more of the components (i.e., the body, door 110, and rear 120) of FOSB 100 are formed of a two-sheet (“twinsheet”) thermoformed structure, representing interior and exterior sides of the particular components of FOSB 100 (twin-sheet). Single or multiple sheet structures are also contemplated. In another embodiment, one or more of the components of FOSB 100 are formed by blow-molding in which a polymer is extruded through a die in a tube-like fashion then pinched off by a mold that forms the part as air is injected into the cavity forcing the cylinder walls to contort to the cavity walls.

Top 130, base 140, first side 150, and second side 160 of FOSB 100 are formed as a single body and distinguished from one another (into defined panels) by laterally extending plication or fold regions in the body. In one embodiment, top 130, bottom 140, first side 150, and second side 160 are a single unit of connected panels folded at plications (e.g., weak areas of the thermoformed plastic) to form a rectangular (e.g., square) body structure. FIG. 1 shows separately formed door 110 and rear 120 connected to the body structure. Representatively, door 110 is connected to first side 150 and second side 160 by mating latch components. Representatively, FIG. 1 shows protruding latch components 115 each extending from top 110 with an interiorly protruding edge or shelf (not shown) to mate with latch components on second side 160. Representatively, the latch components of first side 150 and second side 160 include opposing protruding edges or shelves. Representatively, a protruding edge or shelf of an edge latch component 115 is extended by force over an opposing edge of a latch component on second side 160 (not shown). The connection of rear 120 to first side 150 and second side 160 may be similar. In another embodiment, rear 120 is connected by a friction “snap” type fit. In alternative embodiments, door 110 and/or rear 120 may be sized to fit into place over or within first side 150 and second side 160, respectively, so that door 110 and rear 120 may be connected to first side 150 and second side 160 by mating, friction or with an adhesive.

In one embodiment, FOSB 100 is designed to be compatible with an IC tool load-port or a nest for common machine interface of wafers from a FOSB. FOSB 100 may also be compatible with handling vehicles, such as automated guided vehicles (AGVs) or overhead vehicles (OHVs). An exterior surface of base 140 of FOSB includes, but may not be limited to, carrier sensing pads 175 and V blocks 170 positioned, in one embodiment, according to one industry standard (e.g., SEMI M31-0999) to mate with a kinematic coupling. Representatively, in compliance with SEMI M31-0999, V blocks 170 have a height dimension that extends from the plane defined by the exterior surface of base 140 (e.g., approximately two millimeters (2 mm) above the plane). Base 140 also includes info pads (info pads 180A, 180B, 180C, and 180D). According to SEMI M31-0999, the info pads may communicate information about FOSB 100 to an IC manufacturing tool. For example, info pad 180C representatively may indicate the capacity of FOSB 100 (e.g., the number of wafers inside) by a distance info pad 180C extends from a surface of base 140. In addition to info pads, FOSB 100 may include a location for a radio frequency (RF) pill to be placed, such as on rear 120, that may contain information about FOSB 100. It is appreciated that an RF pill may be placed anywhere on the FOSB.

Referring to FIG. 1, base 140 of FOSB 100 may optionally include, in one embodiment, areas 190 designated as conveyor rails extending longitudinally on opposing sides of the exterior surface of base 140. Areas 190 may act as rails for conveyors or forklifts. Base 140 may also include a number of stiffening features 185, typically depressions or dimples formed by molding in the exterior surface. Stiffening features may also optionally be included on other panels.

FIG. 1 shows second side 160 including handles 165 to allow FOSB 100 to be carried/loaded. The handles, in one embodiment, are optional and are formed, for example, by molding into second side 160 (e.g., through depressions or protrusions). Similar handles may be located/formed in first side 150. In another embodiment, handles may be located vertically on first side 150 and second side 160. Representatively, handles may be tucked up and under at a position where door 110 connects to first side 150 and/or second side 160. First side 150 and second side 160 may each also include one or more latch components for connecting door 110 thereto (e.g., through latch component 115).

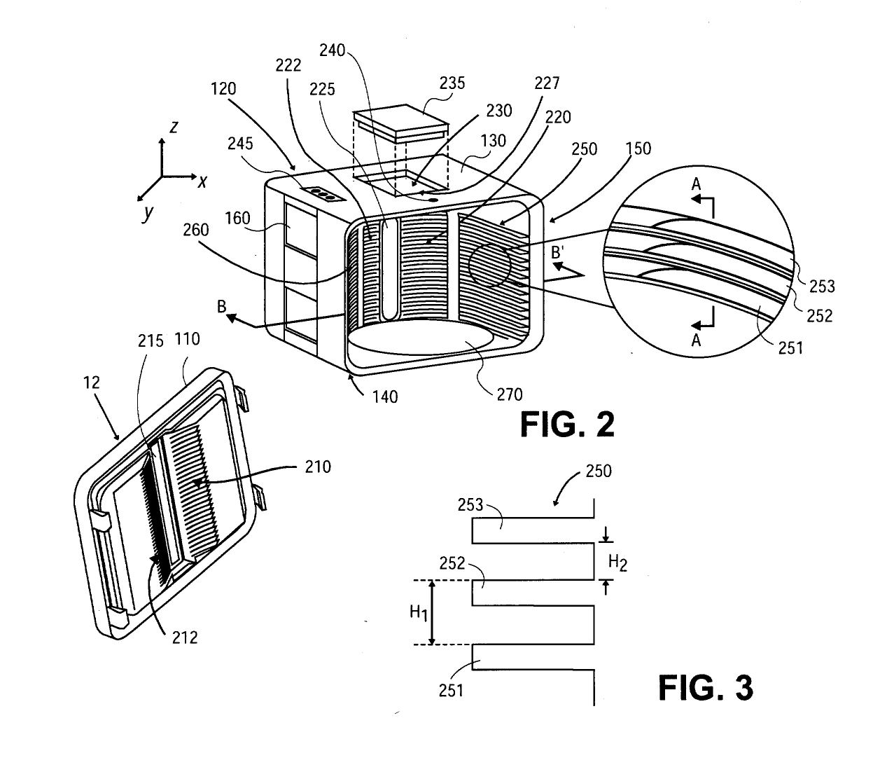

FIG. 2 shows the FOSB of FIG. 1 from another angle. In this embodiment, FOSB 100 is rotated forward and clockwise so that door 110 faces forward on the page. Door 110 has been removed to expose an interior of FOSB 100. From this view, an interior side of door 110, rear 120, and first side 150 are visible. FIG. 2 also shows wafer 270 positioned within an interior of FOSB 100 covering from view an interior side of base 140.

In one embodiment, the interior of FOSB 100 includes components for supporting wafers, for example, up to 25 300 mm wafers according to one current standard (e.g., SEMI M31-0999). In other embodiments, the capacity of FOSB 100 may be modified to support more or less than 25 wafers or to support wafers of different size. Referring to FIG. 2, an interior of FOSB 100 includes 25 laterally extending shelves on each of first side 150 (shelves 250) and second side 160 (shelves 260). The shelves are formed (e.g., by molding) into the body of the individual components, for example, in a thermoform or blow molding process. Shelf portions are also formed on an interior side of door 110 (shelf portions 210 and 212) and rear 120 (shelf portions 220 and 222) by a similar process. Alternatively, the shelves and shelf portions may be formed as inserts that are connected (e.g., by adhesive or fastener) to an interior side of first side 150, second side 160, door 110 and rear 120, respectively. In the embodiment shown in FIG. 2, shelf portions 210 and 212 of door 110 are separated by a longitudinally extending window of, for example, a transparent plastic material. Similarly, shelf portions 220 and 222 of rear 120 are separated by longitudinally extending window 225 of, for example, a transparent plastic material. The windows are optional.

The magnified portion of an interior of first side 150 shows further details of shelves 250. It is appreciated that, in one embodiment, shelves on second side 160 of FOSB 100 are similarly configured. Specifically, the inset shows three shelves 251, 252 and 253. Each shelf extends interiorly from a plane defining an interior surface of first side 150 to provide sufficient surface area (in conjunction with other shelves/shelf portions) to support a wafer.

FIG. 3 shows a cross-section through line A-A′ of FIG. 2. Referring to FIG. 3, shelves 251, 252, and 253 are shown. According to SEMI M31-0999, representative pitch, H₁, between adjacent shelves (e.g., shelf 251 and shelf 252) is on order of 10 millimeters for a FOSB capable of holding 25 300 mm wafers. A representative distance, H₂, between a superior surface of a shelf and an inferior surface of a superior shelf is on the order of six millimeters or more. A typical 300 mm wafer has a thickness on the order of 0.775 mm±0.025.

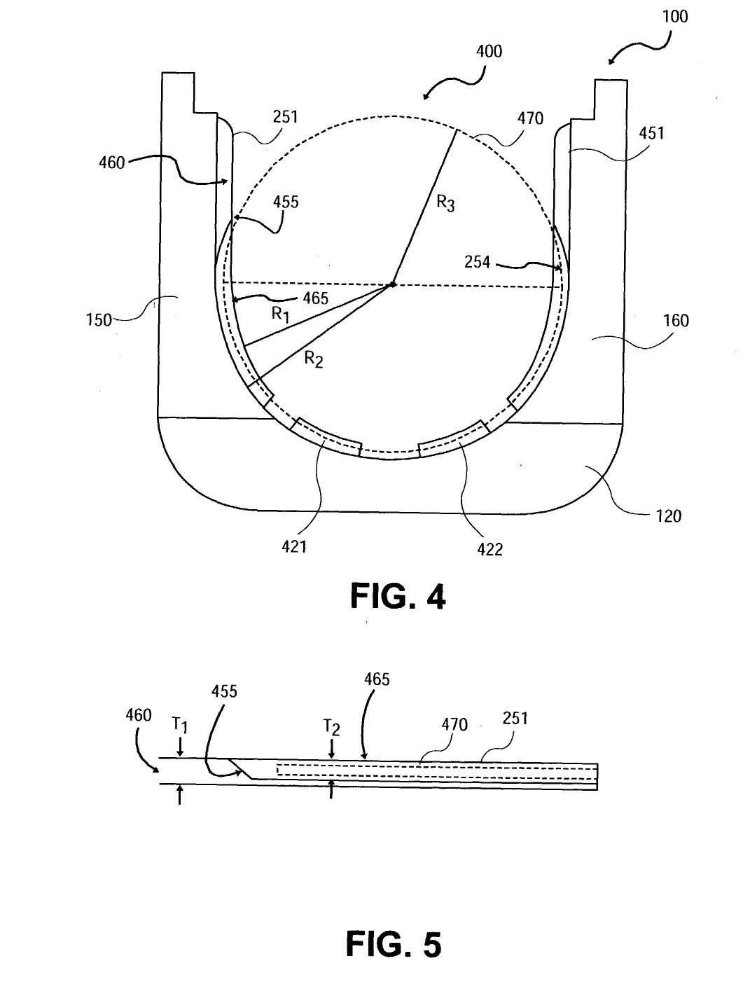

FIG. 4 shows a cross-section through line B-B′ of FIG. 2. From this view, an interior of first side 150, second side 160 and rear 120 are illustrated. First side 150 includes shelf 251. FIG. 5 illustrates a side view of shelf 251. Second side 160 includes shelf 451. Rear 120 may include shelf portions 421 and 422 separated, for example, by a longitudinally extending window (not shown). When assembled, a portion of shelf 251 (first side 150), shelf 451 (second side 160), shelf portion 421 (rear 120), and shelf portion 422 (rear portion 120) lie in a similar plane. Collectively, when assembled, the shelves and shelf portions extend interiorly from the individual FOSB portions (first side 150, second side 160, and rear 120) to provide support for a wafer placed in FOSB 100.

Referring to shelf 251 and FIG. 4 and FIG. 5, in one embodiment, complying with SEMI M31-0999, shelf 251 includes first portion 460 having a thickness, T₁. Shelf 251 also includes portion 465 having a thickness, T₂, that is less than T₁. Portion 465 is, for example, an indentation or recess in a superior surface of shelf 251. A wafer, such as wafer 470 (illustrated in ghost lines) is intended to be seated in second portion 465 when wafer 470 is completely within an interior of FOSB 100. In this manner, junction 455 between first portion 460 and second portion 465 acts as a support stop, a front support stop, for wafer 470 in FOSB 100. The front support stop or pitch protection reduces the ability of a wafer to inadvertently slide out of the front door.

Shelf 251 of first side 150 has been described in detail. Shelf 451 of second side 160 is, in one embodiment, arranged similarly although a mirror image of shelf 251. Shelf portion 421 and shelf portion 422 of rear 120 include a horizontal portion in a plane similar to a horizontal surface of second portion 465 of shelf 251 relative to a datum through the top and bottom of FOSB 100. A collective shelf of first portion 465 (shelf 251), a similar portion of shelf 451 of second side 160 and shelf portion 421 and shelf portion 422 of rear 120 may be in compliance with an industry standard for a FOSB. Representatively, a collective shelf has, in one embodiment, an interior radius, R₁, of approximately 150 mm or less and an exterior radius, R₂, of approximately 152 mm or more. In this manner, a 300 mm wafer will be supported by the collective shelf.

Referring again to FIG. 2, in one embodiment, top 130 of FOSB 100 includes optional automation handling flange 235 that may be positioned, through a frictional slide-in fit or other coupling method, to extend superiorly (as viewed) from a plane defined by an exterior surface of top 130. According to SEMI M31-0999, automation handling flange 235 allows for manipulating FOSB 100. Representatively, automation handling flange 235 may extend approximately at least 15 mm above an exterior surface of top 130 when deployed for automated handling.

Top 130 of FOSB 100 also includes filter opening 240 for an optional filter. A filter may be inserted around filter opening 240, for example, to regulate an environmental pressure equalization of FOSB 100.

An additional, optional feature incorporated into FOSB 100 is indicator 245. Indicator 245 may be a manual or electronic indication of, for example, how many times FOSB 100 has been used to transport wafers. A representative manual indication for indicator 245 is, for example, depressible dimples. A depressed dimple may indicate one use. Two depressed dimples, two uses. An electronic indication for indicator 245 is, for example, a light emitting diode or radio frequency device that may be tripped, for example, after each use.

An alternative indication for optional indicator 245 of FOSB 100 is an indication of a level of shock that FOSB 100 may have experienced. For example, indicator 245 may include a switch that is triggered (either manually or electronically) when FOSB 100 is subjected to a particular level of stress or shock. Representatively, a weighted switch or a motion-sensitive switch may actuate upon a certain stress or shock (a predetermined magnitude) received by FOSB 100. The switch would then indicate that FOSB 100 may not be suitable for further use.

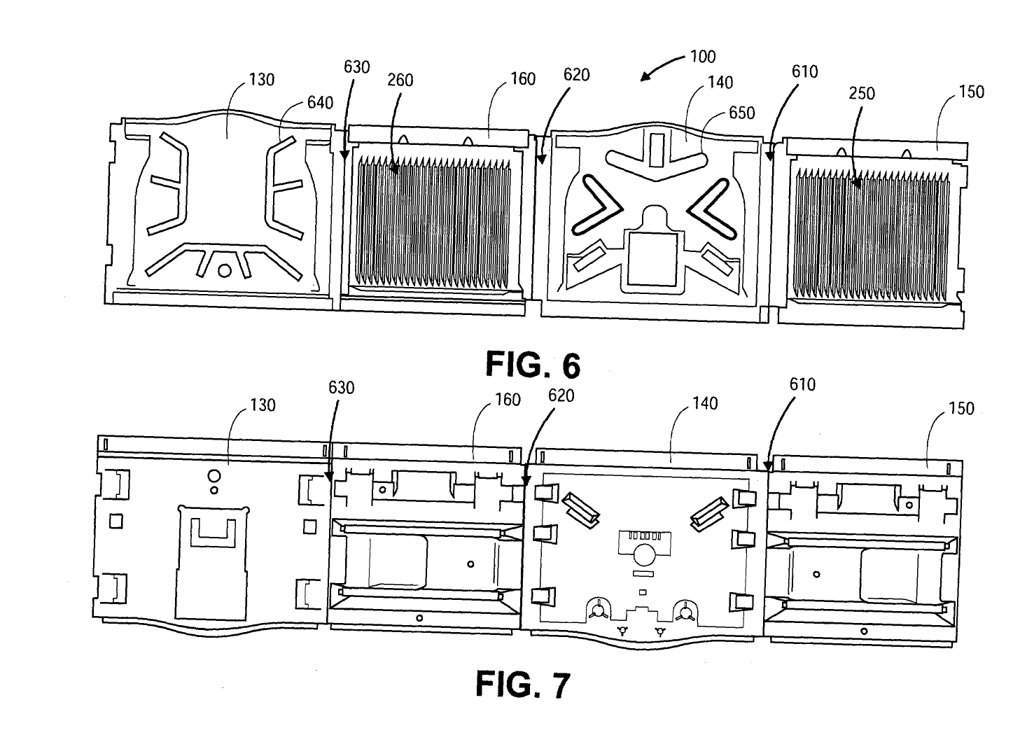

FIG. 6 shows components of the body of FOSB 100 (excluding door 110 and rear 120), disposed in a linear arrangement. As noted above, the body parts of FOSB 100 consisting of top 130, bottom 140, first side 150, and second side 160 may be formed as a single unitary body of, for example, thermoformed or blow-molded, multiple sheet (e.g., twin-sheet polymer or plastic). The individual sections of the body are distinguished from one another by folds or plications representing, for example, weakened portions of a twin-sheet body. In this manner, the individual components are hingedly joined by way of the plications or folds. FIG. 6 shows plication 610 between first side 150 and bottom 140; second plication 620 between bottom 140 and second side 160; and third plication 630 between second side 160 and top 130. Each plication (plication 610, plication 620, and plication 630) extends laterally as a commissure or line of union or junction between two components of the body of FOSB 100. The plications allow the components of the body to be plicated or folded at respective plications into a rectangular unit. When the body is folded into a rectangular shape, first side 150 may be connected to top 130 through a mating hatch.

FIG. 6 shows interior portions of top 130, bottom 140, first side 150 and second side 160. In terms of a twin-sheet thermoformed body, FIG. 6 shows one embodiment of a molding of a first of two sheets. From this view, shelves 250 of first side 150 and shelves 260 of second side 160 are illustrated. Also illustrated are representative stiffening features 640 on top 130 and stiffening features 650 on bottom 140.

FIG. 7 shows a second side of body components of FOSB 100 (e.g., an exterior side). FIG. 7 shows, for example, the molding of a second sheet of a twin-sheet thermoformed body component for FOSB 100. Illustrated in FIG. 7 are first plication 610, second plication 620, and third plication 630.

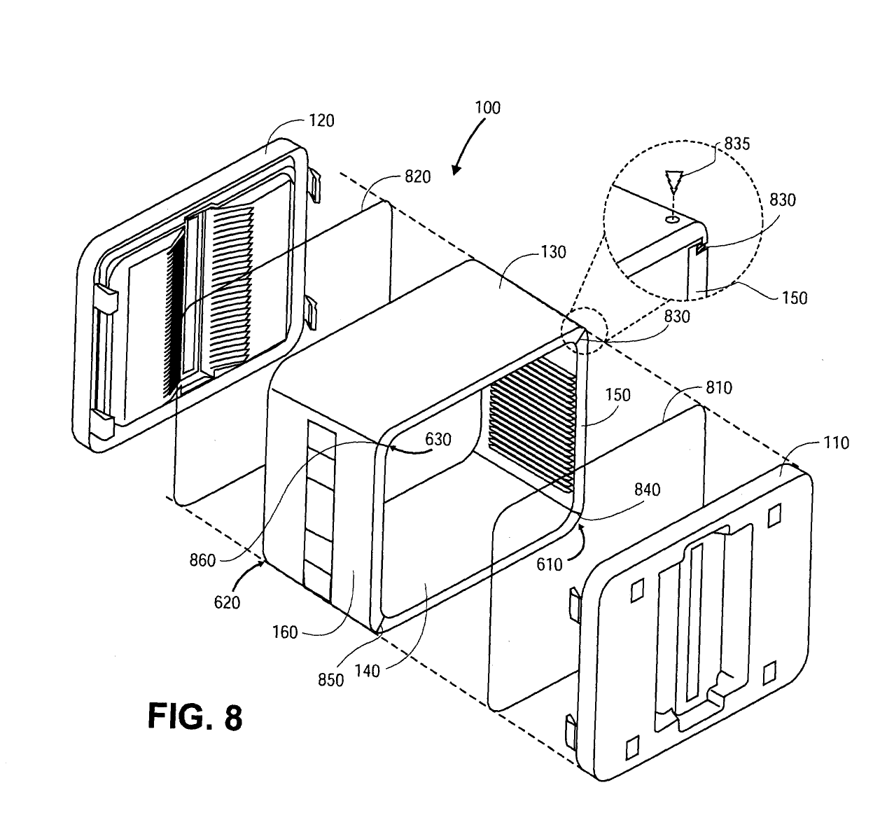

FIG. 8 shows an exploded view of components of FOSB 100. FIG. 8 shows the body of FOSB 100 folded at plications 610, 620, and 630 into a rectangular structure consisting of top 130, bottom 140, first side 150 and second side 160. In one embodiment, lateral extending gasket 830 is inserted at a commissure or line of junction between top 130 and first side 150. Top 130 may be connected to first side 150 by L-shaped mating folds of top 130 and first side 150, respectively. The mating interlock of these folds may be fastened together with, for example, riveting-type, “Christmas tree” fasteners 835. FIG. 8 also shows laterally extending gasket 840 at plication 610; laterally extending gasket 850 at plication 620; and laterally extending gasket 860 at plication 630. FIG. 8 also shows rectangular gasket 810 and rectangular gasket 820 positioned between door 110 and rear 120 and the other body components of FOSB 100, respectively.

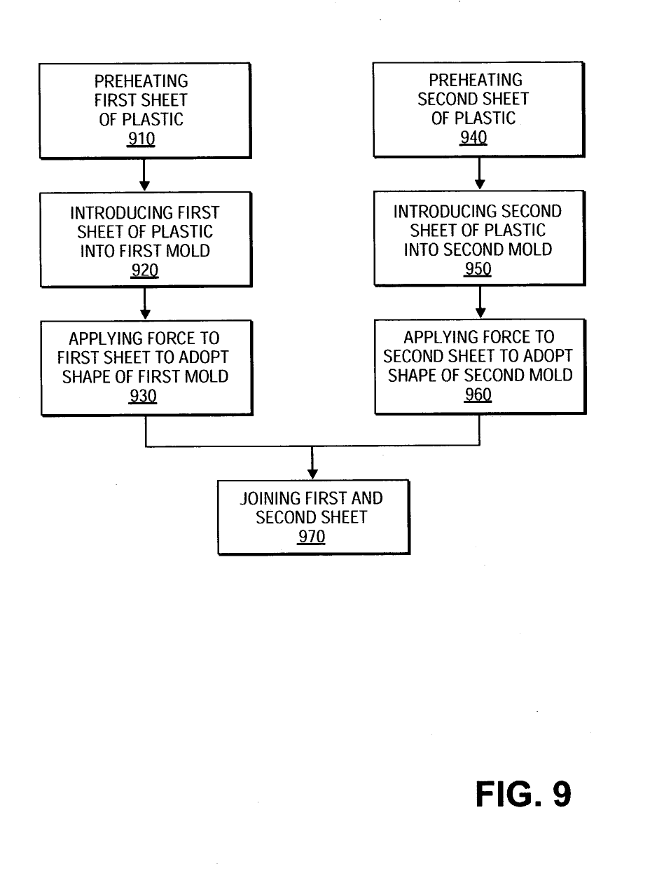

FIG. 9 illustrates a flow chart of a representative process for forming thermoformed components suitable for use in constructing a FOSB. A twin sheet thermoform process is described. A material for a FOSB may be a plastic material such as, but not limited to, a polycarbonate, polyethylene (e.g., high density polyethylene (HDPE)), polypropylene, acrylic (acrylate), glycol-modified polyethylene terephthalate, alkyl benzene sulfonate, and various mixtures of one or more of the noted polymers or others. A suitable material may further include fillers, such as talc. One composition is, for example, 75 percent HDPE and 25 percent filler (e.g., talc) co-extruded into pellets. The pellets may be used to form a first sheet and a second sheet of polymer or plastic material, by, for example, extrusion techniques.

In one embodiment, the first sheet of plastic is preheated to a suitable temperature to soften the material to allow molding (block 910). Representatively, a temperature is sufficient to allow manipulating of the sheet into a shape of a mold to which the sheet is brought into contact. It is appreciated that the particular polymer material selected will contribute to a selection of an approriate preheat temperature (e.g., a melting point of a polymer). The first sheet is then introduced into a first mold (block 920). Representatively, the first mold may include the appropriate shapes for an interior of body components of FOSB 100. FIG. 6 is a representation of a shape (shapes) that may be desired to be achieved from a single mold (e.g., four panels of FOSB 100). Once the first sheet is placed into a first mold, a force is applied to the first sheet to give shape to the first sheet of plastic consistent with the mold (block 930). One suitable force is a vacuum force.

Concurrently with or subsequent to a molding of a first sheet of plastic, a second sheet of polymer or plastic material may be preheated (block 940). The second sheet of plastic is introduced into a second mold (block 950). Representatively, where the first sheet and first mold formed a sheet of plastic similar to the shape illustrated in FIG. 6, the second mold may form the shape illustrated in FIG. 7 (e.g., the exterior of FOSB 100). To give shape to the second sheet of plastic, a force, such as a vacuum force, is applied to the second sheet in the second mold (block 960). Once a desired shape has been given to the first sheet and the second sheet, the first sheet and second sheet are joined, such as thermally and/or pressure joined at their ends and planarly, to yield a thermoformed twin-sheet structure (block 970). It is appreciated that each component of, for example, FOSB 100 (each body component) may be formed as a multiple-sheet thermoformed structure. Alternatively, one or more components may be formed as a multiple-sheet thermoformed structure or other plastic structure. For example, windows in a door and/or rear of the structure, in one embodiment, are triple sheet structures.

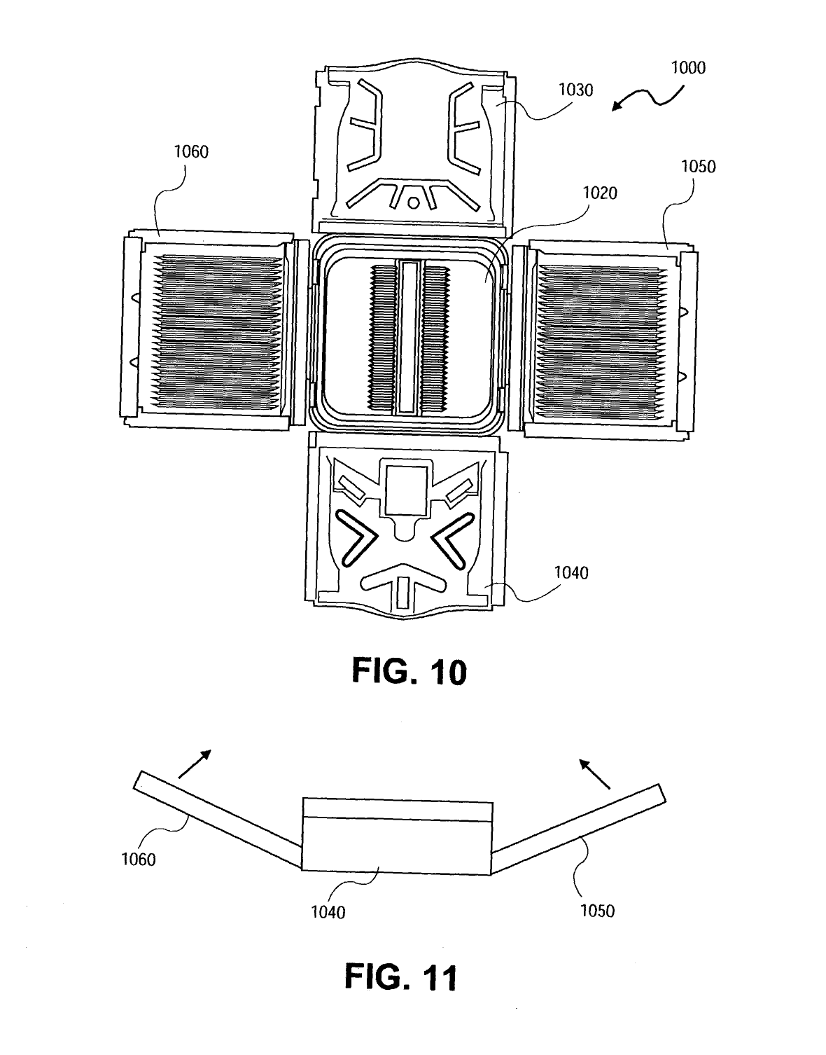

In the embodiment described above with respect to FIGS. 1-8, body portions of the FOSB including of top 130, bottom 140, first side 150, and second side 160 were formed as a single unit or body distinguished by plications that allowed folding or hinging of the individual body components or panels. FIGS. 10 and 11 illustrate another embodiment of a suitable, possibly multiple sheet (e.g., twin-sheet) thermoformed or blow molded structure. FOSB 1000 includes, in this embodiment, five panels as a unitary body including, rear 1020, top 1030, bottom 1040, first side 1050, and second side 1060. Rear 120, in this embodiment, is directly connected to each of top 1030, bottom 1040, first side 1050, and second side 1060. The individual components or panels are hingedly connected to one another through plications or folds as described above with respect to FOSB 100. FIG. 10 shows an interior side view of the structure. FIG. 11 illustrates FOSB 1000 being folded at plications or folds into a rectangular structure.

In addition to the above embodiments where an FOSB is formed by assembling panels at folds or plications, other embodiments are also contemplated. For example, multiple panels (e.g., side portions and top and bottom portions and possibly rear portion) may be formed from a single mold without plications. In this manner, each shelf or wafer support could be a continuous structure about the interior of the FOSB. Alternatively, the panels may be formed as distinct units (from distinct molds) and assembled together by fasteners, friction fit or adhesive.

A FOSB of thermoformed or blow-molded components/panels offer shock resistance to components (e.g., wafers) contained therein. A multiple sheet structure, provides an improved measure of shock resistance over single sheet structures.

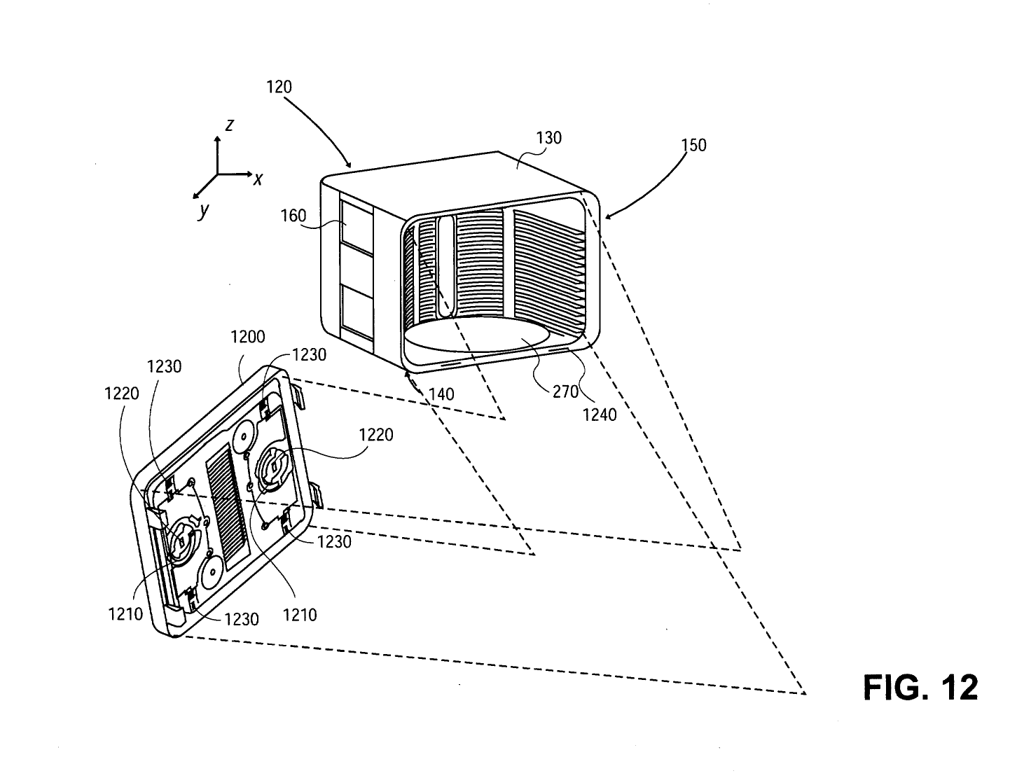

A FOSB such as described above with respect to FIGS. 1-8 and the accompanying text, may also be compatible, in one embodiment, with a shipping-box front opening mechanical interface that itself is compatible with the port that conforms to an industry standard for automated doors (e.g., SEMI E62-0302A, “Provisional Specification for 300 mm Front-Opening Interface Mechanical Standard (FIMS),” Sep. 18, 2001). FIG. 12 shows an illustration of an automated door suitable for use with FOSB 100. In this context, FOSB 100 might be shipped to an IC manufacturing facility with door 110. At the manufacturing facility, door 110 could be removed and replaced with an automated door. FIG. 12 shows FOSB 100 including rear 120, top 130, bottom 140, first side 150, and second side 160. Door 110 has been removed exposing an interior of FOSB 100. FIG. 12 also shows automated door 1200.

Door 1200, in one embodiment, is designed to fit on an inner rim/opening ledge of FOSB 100 (e.g., on an inner door frame defined by top 130, bottom 140, first side 150, and second side 160). Door 1200 is used in place of a manual door (e.g., door 110). Such doors are used, for example, in order for the FOSB to be handled as a wafer carrier on machine centers. Such machines engage the FOSB and open them through the automated doors in a handling operation.

A typical automated door, such as door 1200, is formed of injection molded plastic. Door 1200 includes one to two turning cams 1210 that are engaged by a keyway that the machine interfaces. Keys from a machine slide into cam keyways 1220 and turn cams 1210. Cams 1210 actuate plastic arms or tabs 1230 that extend/retract into recessed pocket features 1240 in the door frame defined by top 130, bottom 140, first side 150, and second side 160 (e.g., 2-3 mms recessed slots).

When an automated door is inserted on FOSB 100, cams 1210 are oriented so that the machine keys can be inserted or withdrawn. In this position, tabs 1230 are in pockets 1240 and door 1200 is seated in the door frame. Door tabs may engage FOSB 100 on horizontal sides (e.g., first side 150 and second side 160) of the door frame in two positions (e.g., one on each side), or on the top and bottom (e.g., top 130 and bottom 140) of the door frame surfaces at four locations (e.g., left and right (top and bottom)) as shown.

To remove an automated door, a machine inserts keys into keyways 1220. The machine turns the keys approximately 90 degrees which in turn withdraws tabs 1230 into the internal of door 1200. The keys on the machine are now engaged into cams 1210 and the machine can pull the door of FOSB 100. The machine removes the door out of the way and FOSB 100 will be engaged on a load port and the wafers accessed.

In addition to other features, an interior side of door 1200 may include wafer engaging features to retain (e.g., lightly catch/hold) wafers for mild protection during handling when door 1200 is used on FOSB 100. An exterior side of door 1200 may further include handles to allow manual actuation of cams 1210 that, in turn, activate tabs 1230. In addition, handles may enable holding of door 1200. An exterior side of door 1200 may also include holes for registration pins and door presence sensing areas.

In the preceding detailed description, reference has been made to specific embodiments thereof. It will, however, be evident that various modifications and changes may be made thereto without departing from the broader spirit and scope of the claims. The specification and drawings are, accordingly, to be regarded in an illustrative rather than a restrictive sense.

What is claimed is:

1. An apparatus comprising:
a thermoformed or blow-molded tote suitable for containing a plurality of wafers in an arrangement that permits machine interaction with at least one of the plurality of the wafers within the tote.

2. The apparatus of claim 1, wherein the tote comprises four side portions of a body, wherein the side portions are defined by plications in the body.

3. The apparatus of claim 2, wherein the body comprises a rear portion defined by the plications.

4. The apparatus of claim 2, wherein opposing side portions of the body comprise an inner portion and an outer portion, the inner portion comprising a plurality of wafer seating plane features.

5. The apparatus of claim 4, wherein a wafer seating plane feature comprises a shelf having a first section and a different second section conforming to the shape of a wafer and planarly offset from the first section.

6. The apparatus of claim 2, further comprising a front portion coupled to the opposing side portions of the body.

7. The apparatus of claim 6, further comprising opposing top portion and bottom portion each adjacent to the opposing side portions.

8. The apparatus of claim 7, wherein the bottom portion comprises an inner portion and an outer portion and the outer portion comprises machine engagement features.

9. The apparatus of claim 1, further comprising a transparent portion formed in the tote that permits visualization of an interior of the tote.

10. The apparatus of claim 1, further comprising an indicator coupled to the tote that indicates a condition of the tote.

11. The apparatus of claim 1, wherein the tote comprises four side portions ends of which define a door frame suitable for engagement by a machine-engageable door.

12. An apparatus comprising:
a tote comprising a thermoformed or blow-molded body having an interior portion comprising a plurality of wafer seating plane features suitable for containing a plurality of wafers.

13. The apparatus of claim 12, wherein the tote comprises four dimensionally similar side portions and a commissure between the side portions comprises a plication region.

14. The apparatus of claim 12, wherein the tote further comprises a front portion coupled to the side portions and a back portion opposite the front portion coupled to the side portions.

15. The apparatus of claim 13, wherein one side portion comprises an inner portion and an outer portion and the outer portion comprises at least one of human and machine engagement features.

16. The apparatus of claim 12, wherein the tote comprises four side portions ends of which define a door frame suitable for engagement by a machine-engageable door.

17. A method comprising:
loading a plurality of wafers in a thermoformed or blow-molded tote onto a tool load port of a machine; and
selecting at least one of the plurality of wafers from the tote.

18. The method of claim 17, further comprising, after selecting the at least one of the plurality of wafers, discarding the tote.

19. The method of claim 17, further comprising, after selecting the at least one of the plurality of wafers, reusing the tote.

20. The method of claim 17, further comprising, after loading, removing a door of the thermoformed tote.

21. The method of claim 20, wherein the door is removed by a machine.
